(19) United States
(12) Patent Application Publication
(10) Pub. No.: US 2014/0353879 A1
(43) Pub. Date: Dec. 4, 2014

(54) METHOD AND DEVICE FOR SCOOPING CANDLE WAX

(71) Applicant: Julie Skirvin, Cedar City, UT (US)

(72) Inventor: Julie Skirvin, Cedar City, UT (US)

(21) Appl. No.: 14/292,603

(22) Filed: May 30, 2014

Related U.S. Application Data
(60) Provisional application No. 61/829,549, filed on May 31, 2013.

(51) Int. Cl. C11C 5/02

(52) U.S. Cl. CPC C11C 5/028
USPC 264/404; 425/279

(57) ABSTRACT

In one embodiment of the present invention, a heated candle scoop comprises a handle, a scoop, and a means for heating the scoop. In one embodiment, the means for heating the scoop comprises a heating element, which may be a typical 80/20 (80% nickel, 20% chromium) wire, ribbon, or strip, or anything that performs a substantially similar function (e.g., ceramics, catalytic heaters, etc.) known to those of skill in the art. It will be appreciated that electrical power, batteries, or gases may be used to heat the element as known to those in the art.

### CROSS-REFERENCE TO RELATED APPLICATIONS

This application claims the benefit of U.S. Provisional Application Ser. No. 61/829,549, filed on May 31, 2013, which is incorporated herein by reference.

### TECHNICAL FIELD

The present invention relates to candles. More particularly, the present invention relates to a novel device and method for making wax tarts for use with candle warmers.

### BACKGROUND

Scented candles have been used for a very long time. However, a lighted candle also poses a substantial risk to persons and property. In fact, according to the National Candle Association, four percent (4%) of all U.S. residential fires are caused by candles. As a result of this risk, candle warmers have increased in popularity. Unlike a typical candle, which requires a wick and fire, a candle warmer typically uses electricity to generate heat that melts a block of wax (known as a “tart”) in a holder. This allows the scent of the candle to be released into the ambient air without the risk of fire associated with wick-burning candles.

However, often times a user is unable to find the desired tart for use in their warmer, even though the desired scent is available as a candle. The user may also have previous candles that they would like to use in a warmer, but there is no effective way to remove the candle from the jar. Lastly, a user lacks the ability to mix multiple candle scents together in the same warmer, especially if the desired tarts are not available for purchase. The present invention seeks to solve these problems.

### SUMMARY OF EXAMPLE EMBODIMENTS

In one embodiment, a heated candle scoop comprises a handle, a scoop, and a means for heating the scoop. In one embodiment, the means for heating the scoop comprises a heating element, which may be a typical 80/20 (80% nickel, 20% chromium) wire, ribbon, or strip, or anything that performs a substantially similar function (e.g., ceramics, catalytic heaters, etc.) known to those of skill in the art. It will be appreciated that electrical power, batteries, or gases may be used to heat the element as known to those in the art.

In another embodiment, a heated candle scoop comprises a handle, a removable scoop, and a means for heating the scoop.

In another embodiment, a candle scoop accessory comprises a scoop and a means to attach the scoop to a soldering iron. The means to attach comprising a shaft for insertion into a shaft-receiving sleeve of a soldering iron in substantially the same manner as a soldering iron “bit” known to those of skill in the art.

A method for scooping candle wax from a candle, the method comprising heating a scoop, inserting the scoop into a candle, or other wax, and removing portions of wax therefrom.

A method of using a soldering iron to remove candle wax, the method comprising attaching a thermally conductive scoop to a soldering iron, inserting the heated scoop into wax, and removing wax therefrom.

### BRIEF DESCRIPTION OF THE DRAWINGS

FIG. 1 is a perspective side view of a heated candle scoop

FIG. 2 is a perspective side view of a heated candle scoop with removable scoop

FIG. 3 is a perspective side view of scoop for use with soldering irons

FIG. 4 is a perspective side view of a scoop with batteries as a power source

### DETAILED DESCRIPTION OF EXAMPLE EMBODIMENTS

The following descriptions depict only example embodiments and are not to be considered limiting of its scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrase “in one embodiment,” or “in an embodiment,” do not necessarily refer to the same embodiment, although they may.

Reference to the drawings is done throughout the disclosure using various numbers. The numbers used are for the convenience of the drafter only and the absence of numbers in an apparent sequence should not be considered limiting and does not imply that additional parts of that particular embodiment exist. Numbering patterns from one embodiment to the other need not imply that each embodiment has similar parts, although it may.

Accordingly, the particular arrangements disclosed are meant to be illustrative only and not limiting as to the scope of the invention, which is to be given the full breadth of the appended claims and any and all equivalents thereof. Although specific terms are employed herein, they are used in a generic and descriptive sense only and not for purposes of limitation. Unless otherwise expressly defined herein, such terms are intended to be given their broad ordinary and customary meaning not inconsistent with that applicable in the relevant industry and without restriction to any specific embodiment hereinafter described. As used herein, the article “a” is intended to include one or more items. When used herein to join a list of items, the term “or” denotes at least one of the items, but does not exclude a plurality of items of the list. For exemplary methods or processes, the sequence and/or arrangement of steps described herein are illustrative and not restrictive.

It should be understood that the steps of any such processes or methods are not limited to being carried out in any particular sequence, arrangement, or with any particular graphics or interface. Indeed, the steps of the disclosed processes or methods generally may be carried out in various different sequences and arrangements while still falling within the scope of the present invention.

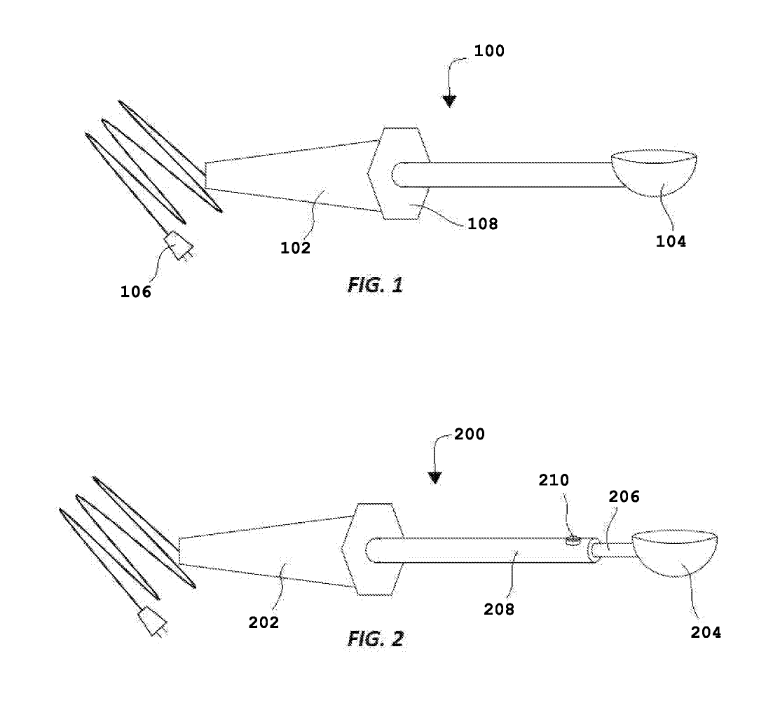

The present disclosure is directed to devices and methods for scooping candle wax. In general, as illustrated in FIG. 1, a heated candle scoop 100 comprises a handle 102, a scoop 104, and a means for heating the scoop. In one embodiment, the means for heating the scoop comprises a heating element, which may be a typical 80/20 (80% nickel, 20% chromium) wire, ribbon, or strip, or anything that performs a substantially similar function (e.g., ceramics, catalytic heaters, etc.) known to those of skill in the art. When a user desires to use the heated candle scoop 100, they connect a power source 106 to heat the scoop 104. Handle 102 is comprised of heat-resistant materials known to those in the art. In one embodiment, a heated candle scoop 100 may also comprise a heat shield 108. Scoop 104 is made of metals or other thermally conductive materials, such as silver, copper, gold, aluminum, brass, steel, or others known to those of skill in the art. In a preferred embodiment, the scoop ranges in size from about 0.42 mm to 1.21 mm in thickness, has a circumference of about 6.35 mm to 63.5 mm, and a depth of about 6.35 mm to 19.05 mm. Although specific sizes have been mentioned herein, it will be appreciated that any size of scoop that easily fits into the opening of a candle, or other wax container, and is thermally conductive is contemplated herein. In a preferred embodiment, the heating element may range between 90-350° Fahrenheit, which may require a range from about 15-100 Watts or greater.

In another embodiment, as shown in FIG. 2, a heated candle scoop 200 comprises a handle 202, a removable scoop 204, and a means for heating the scoop. Scoop 204 further comprises a shaft 206 that couples with a shaft-receiving sleeve 208 and is secured via a securing mechanism 210. In one embodiment, securing mechanism 210 may comprise a tightening screw, a twist and lock mechanism, threads, or other mechanisms known to those of skill in the art.

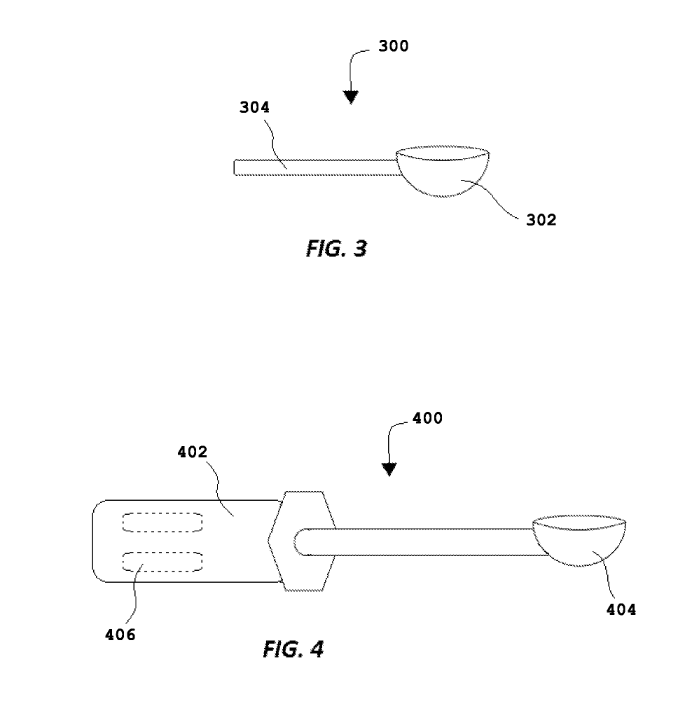

In another embodiment, as shown in FIG. 3, a candle scoop accessory 300 comprises a scoop 302 and a means to attach the scoop to a soldering iron. In one embodiment, the means to attach comprises a shaft 304 for insertion into a shaft-receiving sleeve of a soldering iron (not shown) in substantially the same manner as a soldering iron “bit” known to those of skill in the art. It will be further appreciated by those with skill in the art that shaft 304 may be cylindrical, flat on one side, square, threaded, notched, or otherwise adapted for use in a variety of soldering irons. In a preferred embodiment, shaft 304 is about 3 mm to 6 mm in diameter and about 25-76 mm in length, although not limited to such specifications.

In yet another embodiment, as seen in FIG. 4, a heated candle scoop 400 comprises a handle 402, a scoop 404, and a means for heating the scoop. As shown, heated candle scoop 400 may be cordless and may use other means for a source of power. For example, handle 402 may comprise batteries 406 (e.g., AA, Ni-MH, etc.) as a power source for the heating element. Other cordless variations known in the art, such as gas (e.g., butane) are also contemplated herein.

For example, when a user desires to use candle wax for use in a warmer, the user may power on the candle scoop (AC adapter or batteries), wait for the heating element to heat the scoop to the desired temperature, scoop the wax from the candle, and place it in a warmer or other location. If using the soldering iron adapter, a user will first secure the thermally conductive scoop to the soldering iron, allow the scoop to reach the desired temperature, and then proceed to use the scoop to remove wax from the candle.

What is claimed is:

1. A candle scoop, comprising:
a handle;
a scoop; and
a means for heating the scoop.

2. The candle scoop of claim 1, wherein the handle is heat resistant.

3. The candle scoop of claim 1, wherein the scoop is made of thermally conductive materials.

4. The candle scoop of claim 1, wherein the means for heating the scoop comprises an electric heating element.

5. The candle scoop of claim 4, wherein the electric heating element is powered via an AC adapter.

6. The candle scoop of claim 4, wherein the electric heating element is powered using batteries.

7. The candle scoop of claim 1, wherein the means for heating the scoop comprises using a gas.

8. The candle scoop of claim 1, wherein the scoop is removably attachable.

9. The candle scoop of claim 1, wherein the handle further comprises a heat shield.

10. A method of using a candle scoop, comprising:
heating the scoop to the desired temperature using a heating means;
holding the scoop by the handle; and
scooping wax from a candle or jar.

11. The heating means of claim 10 comprising heating an element using electrical power.

12. The heating means of claim 10 comprising butane or other gases.

13. A method of using a thermally conductive scoop with a soldering iron, the method comprising:
coupling a thermally conductive scoop to a soldering iron;
allowing the scoop to reach the desired temperature; and
using the scoop to remove wax from a candle or jar.

14. A candle scoop, comprising:
a thermally conductive scoop; and
a means for attaching the thermally conductive scoop to a heat source.

15. The candle scoop of claim 14, wherein the means for attaching to a heat source comprises a shaft for coupling to a soldering iron.
